(19) United States
(12) Patent Application Publication
(10) Pub. No.: US 2013/0024900 A1
(43) Pub. Date: Jan. 24, 2013

(54) METHOD AND APPARATUS FOR PROCESSING NON-REAL-TIME BROADCAST SERVICE AND CONTENT TRANSMITTED BY BROADCAST SIGNAL

(71) Applicants: Jong Yeul Suh, Seocho-gu (KR); Gomer Thomas, NE Arlington, WA (US); Jin Pil Kim, Seocho-gu (KR)

(72) Inventors: Jong Yeul Suh, Seocho-gu (KR); Gomer Thomas, NE Arlington, WA (US); Jin Pil Kim, Seocho-gu (KR)

(21) Appl. No.: 13/638,377

(22) PCT Filed: Apr. 1, 2011
(86) PCT No.: PCT/KR2011/002280

§ 371 Date: Sep. 28, 2012

Related U.S. Application Data
(60) Provisional application No. 61/320,761, filed on Apr. 4, 2010.

(51) Int. Cl. H04N 21/472

(52) U.S. Cl. 725/100

(57) ABSTRACT

The present invention relates to a method and an apparatus for delivering an NRT service or NRT content through a broadcast signal. According to one embodiment of the present invention, the method for processing the NRT broadcast service comprises the steps of: receiving a broadcast signal including an IP multicast stream transmitted through a particular Internet protocol (IP) address; parsing a service map table (SMT) for signaling a non-real-time (NRT) service from the IP multicast stream included in the received broadcast signal; parsing a language information descriptor indicative of language information of an element associated with the NRT service at the parsed service map table; parsing, in the parsed language information descriptor, a language type field indicative of the type of language used in the NRT service and an element type field indicative of the type of element associated with the NRT service; and identifying that the language indicated by the language type field is used in the element associated with the NRT service indicated by the parsed element type field, wherein said element type field identifies one of elements which are associated with the NRT service and include a caption element of the NRT service and a text element of the NRT service.

### TECHNICAL FIELD

The present invention relates to a method and apparatus for processing a broadcast service and content included in a broadcast signal.

More particularly, the present invention relates to a method and apparatus for processing a Non Real Time (NRT) broadcast service and content.

### BACKGROUND ART

The advent of the digital broadcast age has brought about a change from a standard definition broadcast to a high definition broadcast. There are consumer demands for more various and higher quality broadcast services. However, broadcast services using conventional broadcast systems have several problems including limited bandwidth allotted to a conventional broadcast station or channel and difficulty in provision of a broadcast service capable of satisfying consumer demand through a broadcast network.

### DISCLOSURE

### Technical Problem

Embodiments of the present invention have been devised to solve the above-described problems of the background art, and an object of the present invention is to enable a consumer centered broadcast service even using a conventional broadcast network and to enhance use efficiency of the conventional broadcast network in order to realize transmission of a high-quality broadcast.

### Technical Solution

To achieve the above-described technical problem, in accordance with one aspect of the present invention, a method for processing a Non Real Time (NRT) broadcast service includes receiving a broadcast signal including an Internet Protocol (IP) multicast stream transmitted through a particular IP address, parsing a Service Map Table (SMT) for signaling the NRT service from the IP multicast stream included in the received broadcast signal, parsing a language information descriptor indicative of language information on an element associated with the NRT service at the parsed service map table, parsing, in the parsed language information descriptor, a language type field indicative of the type of language used in the NRT service and an element type field indicative of the type of an element associated with the NRT service, and identifying that the language indicated by the language type field is used in the element associated with the NRT service indicated by the parsed element type field, wherein the element type field identifies one of elements which are associated with the NRT service and include a caption element of the NRT service and a text element of the NRT service.

The NRT broadcast service/content processing method may further include receiving the broadcast signal through a digital broadcast network, parsing a Virtual Channel Table (VCT) including property information on a virtual channel transmitted by a transport stream, included in the received broadcast signal, if the type of a service indicated by service type information that is included in the parsed VCT is a particular NRT service, parsing a Program Association Table (PAT) including second program number information matched to first program number information that is included in the VCT to identify a program of the virtual channel, parsing a Program Map Table (PMT) identified by a program map packet identifier that is included in the parsed PAT, and identifying the IP multicast stream from transport stream packets indicated by an elementary packet identifier that is included in the parsed PMT.

Here, the text element of the NRT service may be a text element of a web portal service or an electronic book (e-book) service that is provided as the NRT service.

The NRT broadcast service/content processing method may further include displaying a guide list with respect to NRT services by mapping the type of language indicated by the language type field to the NRT service.

In accordance with another aspect of the present invention, a method for processing NRT content transmitted via a broadcast signal includes receiving the broadcast signal including an IP multicast stream transmitted through a particular IP address, parsing an SMT for signaling the NRT service from the IP multicast stream included in the received broadcast signal, parsing an NRT information table including information on the NRT content provided by an NRT service, wherein the NRT information table includes a second service identifier having the same value as a value of a first service identifier that is included in the parsed service map table to identify the NRT service, parsing a language information descriptor indicative of language information on an element associated with the NRT content at the parsed NRT information table, parsing, in the parsed language information descriptor, a language type field indicative of the type of language used in the NRT content and an element type field indicative of the type of an element associated with the NRT content, and identifying that the language indicated by the language type field is used in the element associated with the NRT content indicated by the parsed element type field, wherein the element type field identifies one of elements which are associated with the NRT content and include a caption element of the NRT content and a text element of the NRT content.

The above-described method for processing the NRT content transmitted via the broadcast signal may further include receiving the broadcast signal through a digital broadcast network, parsing a VCT including property information on a virtual channel transmitted by a transport stream, included in the received broadcast signal, if the type of a service indicated by service type information that is included in the parsed VCT is a particular NRT service, parsing a PAT including second program number information matched to first program number information that is included in the VCT to identify a program of the virtual channel, parsing a PMT identified by a program map packet identifier that is included in the parsed PAT, and identifying the IP multicast stream from transport stream packets indicated by an elementary packet identifier that is included in the parsed PMT.

Here, the text element of the NRT content may be a text element of web portal content or electronic book (e-book) content that is provided as the NRT content.

The above-described method for processing the NRT content transmitted via the broadcast signal may further include displaying a guide list with respect to NRT content by mapping the type of language indicated by the language type field to the NRT content.

The SMT may include an NRT service descriptor that includes information on NRT service use or consumption models, and the NRT service descriptor may include an NRT service category field indicative of at least one of the NRT service consumption models including NRT content that can be selected for later downward, web portal content, and NRT content based on a user request.

The displaying may include displaying that the corresponding NRT content is Video on Demand (VoD) content if the NRT service category field indicates that the NRT service consumption model is the NRT content that can be selected for later downloaded, or the NRT content based on the user request, and displaying that the corresponding NRT content is web content if the NRT service category field indicates that the NRT service consumption model is the web portal content.

Also, the above-described method for processing the NRT service/content transmitted via the broadcast signal may be processed by respective functional blocks of an NRT broadcast receiver or a mobile NRT broadcast receiver that will be described hereinafter.

### Advantageous Effects

According to an embodiment of the present invention, it is possible to provide a consumer centered high quality broadcast service using a conventional broadcast network.

More particularly, in relation to provision of an NRT service, it is possible to efficiently deliver additional information on the NRT service and content to a user.

### DESCRIPTION OF DRAWINGS

Hereinafter, features and exemplary embodiments of the present invention will be described in detail with reference to the accompanying drawings.

FIG. 1 is a conceptual diagram showing an NRT service technique according to an embodiment of the present invention.

FIG. 2 is a functional block diagram showing an NRT broadcast receiver according to an embodiment of the present invention.

FIG. 3 is a functional block diagram showing an NRT broadcast receiver according to another embodiment of the present invention.

FIG. 4 is a functional block diagram showing a mobile NRT broadcast receiver that processes an NRT broadcast service according to an embodiment of the present invention.

FIG. 5 is a diagram showing an ISO_{—}639_language_descriptor according to an embodiment of the present invention.

FIG. 6 is a diagram showing the type of an element of an NRT service that is identified by an audio_type field according to an embodiment of the present invention.

FIG. 7 is a diagram showing language information regarding captions and/or text displayed on a per service basis by an electronic program guide according to an embodiment of the present invention.

FIG. 8 is a diagram showing language information regarding captions and/or text displayed on a per content basis by an electronic program guide according to an embodiment of the present invention.

FIG. 9 is a flowchart showing a method for processing an NRT service transmitted via a broadcast signal according to an embodiment of the present invention.

### BEST MODE

Hereinafter, although the preferred embodiments of the present invention will be described in detail with reference to the accompanying drawings and descriptions of the drawings, the present invention is not restricted or limited by the embodiments.

Although the terms used in the following description are selected, as much as possible, from general terms that are widely used at present while taking into consideration of the functions obtained in accordance with the present invention, these terms may be replaced by other terms based on intensions of those skilled in the art, customs, emergence of new technologies, or the like. Also, in a particular case, terms that are arbitrarily selected by the applicant of the present invention may be used. In this case, the meanings of these terms may be described in corresponding description parts of the invention. Accordingly, it should be noted that the terms used herein should be construed based on practical meanings thereof and the whole content of this specification, rather than being simply construed based on names of the terms.

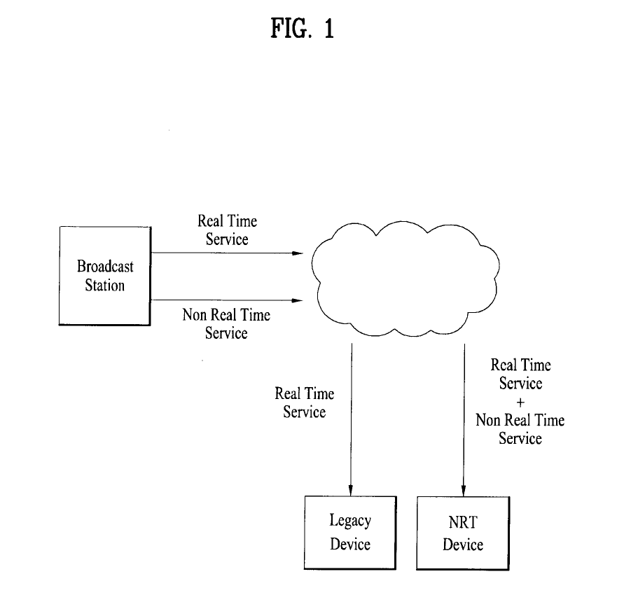

FIG. 1 is a conceptual diagram showing an NRT service technique according to an embodiment of the present invention.

A Non Real Time (NRT) service may be delivered to and stored in a receiver before the receiver uses the corresponding service. More specifically, a broadcast station may transmit an NRT service through a residual bandwidth except for a bandwidth allotted to the broadcast station for transmission of a Real Time (RT) service. For example, in the case of transmission of a Standard Definition (SD) broadcast, data for the SD broadcast generally does not consume the entire bandwidth allotted to the broadcast station. Thus, data for the NRT service may be delivered over the resulting residual bandwidth. This is the same in the case of a High Definition (HD) broadcast service or a 3-Dimensional (3D) service. Moreover, in the case of a broadcast station that does not provide a broadcast service in a late night time slot, it may transmit the NRT service using a broadcast bandwidth allotted for the RT broadcast in a late night time slot. In this case, the data for the NRT service transmitted through the late night time slot may be received in each receiver such that a user can watch the NRT service whenever the user wishes. In addition to the above-described cases, the NRT service may be transmitted through a bandwidth obtained by subtracting a bandwidth for transmission of the RT broadcast from an existing broadcast bandwidth, or through a newly allotted bandwidth for only the NRT service.

In the present invention, as compared to an NRT device that is capable of receiving the NRT service, a receiver to receive a conventional broadcast is referred to as a legacy device. The legacy device is not affected by an NRT service signal even if the NRT service is multiplexed with a conventional broadcast service in a broadcast signal. In other words, the legacy device is not affected by operation of an NRT stream included in a channel. Thus, the legacy device cannot receive the NRT service, or cannot process the received NRT service. Accordingly, provision of the NRT service according to the present invention may be realized under maintenance of compatibility with the legacy device. In conclusion, the NRT service according to an embodiment of the present invention may transmit an RT broadcast signal to the legacy device and may transmit the RT broadcast signal and an NRT broadcast signal to the NRT device through the same broadcast stream. In an embodiment, this operation may be accomplished by allowing only the NRT device to process information for identification of the NRT service in the course of signaling the NRT service while preventing the legacy device from recognizing the information.

The NRT service includes news clips, weather information, advertisement service, and Push Video on Demand (VoD) content, for example. In addition, the NRT service may provide a variety of services that a conventional broadcast service cannot provide. For example, the NRT service may enable provision of web portal pages and provision of electronic book content.

The RT service and the NRT service may be transmitted through the same path or through different paths (for example, channels), and may be transmitted through an MPEG-2 Transport Packet (TP) or an Internet Protocol (IP) datagram. A broadcast receiver according to the present invention may identify the NRT service using signaling information and announcement information transmitted through a Service Signaling Channel (SSC) if the NRT service and the RT service are transmitted through the same path.

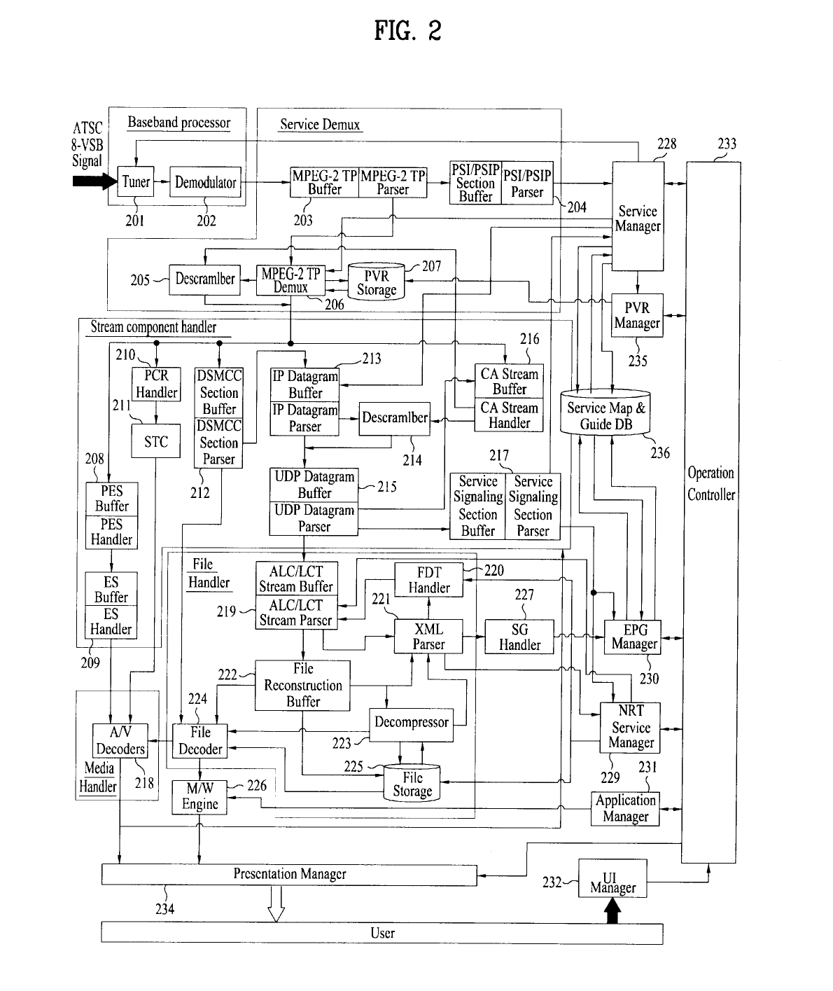

FIG. 2 is a functional block diagram showing an NRT broadcast receiver according to an embodiment of the present invention.

The NRT broadcast signal according to the embodiment of the present invention may basically include a baseband processor, an MPEG-2 service Demux, a stream component handler, a media handler, a file handler, and other parts.

The baseband processor may include a tuner 201 and a demodulator 202.

The tuner 201 may detect a Radio Frequency (RF) signal transmitted over the air, and extract a symbol. Here, the tuner 201 may be controlled by a service manager 228 that will be described hereinafter. The demodulator 202 may demodulate the symbol extracted from the tuner 201, and restore meaningful data.

The MPEG-2 service Demux may include an MPEG-2 TP buffer/parser 203, a PSI/PSIP section buffer/parser 204, a descrambler 205, an MPEG-2 TP Demux 206, and a PVR storage 207.

The MPEG-2 TP buffer/parser 203 may buffer and restore an MPEG-2 TP transmitted through a signal, and detect and process a TP header. The PSI/PSIP section buffer/parser 204 buffers and analyzes Program Service Information/Program Service Information Protocol (PSI/PSIP) section data transmitted through an MPEG-2 TS. Here, the analyzed PSI/PSIP data is collected by the service manager 226, and a database (DB) stores the collected PSI/PSIP data in a service map or guide data format. The descrambler 205 restores scrambled packet payload data among the MPEG-2 TP using, for example, an encryption key delivered from a Conditional Access (CA) stream handler 216. The MPEG-2 TP Demux 206 filters a desired TP that the receiver wishes to process among the MPEG-2 TP transmitted through a signal or an MPEG-2 TP stored in the PVR storage 207, and then relays the filtered MPEG-2 TP to a next processing module. Here, the MPEG-2 TP Demux 206 may be controlled by the service manager 228 and a PVR manager 235. The Personal Video Recorder (PVR) storage 207 stores the received MPEG-2 TP in response to a user request, and outputs the MPEG-2 TP in response to a user request. Here, the PVR storage 207 is controlled by the PVR manager 235.

The stream component handler may include a Packetized Elementary Stream (PES) buffer/handler 208, an Elementary Stream (ES) buffer/handler 209, a Program Clock Reference (PCR) handler 210, a System Time Clock (STC) 211, a Digital Storage Media Command and Control (DSM-CC) section buffer/parser 212, an IP datagram buffer/header parser 213, a descrambler 214, a User Datagram Protocol (UDP) datagram buffer/parser 215, a CA stream buffer/handler 216, and a service signaling section buffer/handler 217.

The PES buffer/handler 208 buffers and restores a PES transmitted through the MPEG-2 TS. The ES buffer/handler 209 buffers and restores an ES, such as audio data and video data, for example, transmitted in a PES format, and transmits the restored ES to A/V decoders 218. The PCR handler 210 processes PCR data used for time synchronization of an audio stream and a video stream, for example. The STC 211 corrects clock values of the A/V decoders 218 using a reference clock value delivered through the PCR handler 210, and enables time synchronization thereof. The DSM-CC section buffer/handler 212 buffers and processes DSM-CC section data for IP datagram encapsulation and transmission of a file through the MPEG-2 TP, for example. The IP datagram buffer/header parser 213 buffers and restores an IP datagram that is encapsulated via a DSM-CC addressable section and transmitted through the MPEG-2 TP. The IP datagram buffer/header parser 213 analyzes a header of each datagram via the restoration process. Here, the IP datagram buffer/header parser 213 may be controlled by the service manager 228. The descrambler 214 restores payload data using, for example, the encryption key transmitted from the CA stream handler 216 if scrambling is applied to the corresponding payload among the received IP datagram. The UDP datagram buffer/parser 215 buffers and restores a UDP datagram transmitted through the IP datagram, and analyzes and processes a UDP header. The CA stream buffer/handler 216 buffers and processes data, such as, for example, key values for descrambling including an Entitlement Management Message (EMM) or Entitlement Control Message (ECM) transmitted for a conditional access function, transmitted through the MPEG-2 TP or an IP stream. Here, an output of the CA stream buffer/handler 216 is transmitted to the descrambler 214, which performs decryption of the MPEG-2 TP or an IP datagram that transmits A/V data and file data, for example. The service signaling section buffer/parser 217 processes a Service Map Table (SMP), an NRT Information Table (NRT-IT), and associated descriptors for signaling the NRT service according to the present invention. Here, the processed signaling information is transmitted to an NRT service manager 229.

The media handler may include the A/V decoders 218.

The A/V decoders 218 compress or decode audio data and video data transmitted through the ES handler 209, and process the data to present the data to the user.

The file handler includes an ALC/LCT buffer/parser 219, a File Description Table (FDT) handler 220, an Extensible Markup Language (XML) parser 221, a file reconstruction buffer 222, a decompressor 223, a file decoder 224, and a file storage 225.

The Asynchronous Layered Coding/Layered Coding Transport (ALC/LCT) buffer/parser 219 buffers and restores ALC/LCT data transmitted in a UDP/IP stream, and analyzes an ALC/LCT header and a header extension. Here, the ALC/LCT buffer/parser 219 may be controlled by the NRT service manger 229. The FDT handler 220 analyzes and processes an FDT of a File Delivery Over Unidirectional Transport (FLUTE) protocol transmitted through an ALC/LCT session. The ALC/LCT buffer/parser may transmit the processed FDT to the NRT service manager 229. Here, the FDT handler 220 may be controlled by the NRT service manager 229. The XML parser 221 analyzes an XML document transmitted through the ALC/LCT session, and transmits the analyzed data to the FDT handler 220 and the SG handler 227, for example. The file reconstruction buffer 222 restores a file transmitted in the ALC/LCT and FLUTE sessions. The decompressor 223 performs a decompression process if the file transmitted in the ALC/LCT and FLUTE sessions is a compressed file. The file decoder 224 decodes the file restored in the file reconstruction buffer 222, the file decompressed in the decompressor 223, or a file extracted from the file storage 225. The file storage 225 stores and extracts the received file. Here, the received file may include NRT content.

In addition, the NRT broadcast receiver according to the embodiment of the present invention includes the middleware (M/W) engine 226, the service guide handler 227, the service manager 228, the NRT service manager 229, an Electronic Program Guide (EPG) manager 230, an application manager 231, a User Interface (UI) manager 232, a presentation manager 234, the PVR manager 235, and an operation controller 233 to control other functional parts.

The M/W engine 226 processes data, such as, for example, files except for an A/V stream, transmitted through the DSM-CC section or the DSM-CC addressable section and the IP datagram, for example, and transmits the processed data to the presentation manager 234. The SG handler 227 collects and analyzes service guide data transmitted in an XML document format, and transmits the analyzed data to the EPG manager 230. The service manager 228 collects and analyzes the PSI/PSIP data transmitted through the MPEG-2 TS and the service signaling section data transmitted in the IP stream to thereby make a service map, and stores the service map in a service map & guide database to control user access to a desired service. Here, the service manager 228 is controlled by the operation controller 230, and controls the tuner 201, the MPEG-2 TP Demux 206, the IP datagram buffer/handler 213, and the NRT service manager 229, for example. The NRT service manager 229 performs general management with respect to the NRT service transmitted in an object/file format through the FLUTE session on an IP layer. The NRT service manager 229 parses signaling information transmitted from the service signaling section buffer/parser 217. The parsed signaling information may be transmitted to and stored in the service map & guide database 236. Also, the NRT service manager 229 transmits the SMT and/or NRT-IT, which is content associated with a service guide, among the signaling information, to the EPG manager 230, and controls formation of EPG data. Here, the NRT service manager 229 controls the FDT handler 220 and the file storage 225, for example. As such, the NRT service manager 229 parses the FDT received from the FDT handler 220 and controls storage of the NRT content in a hierarchy format in the file storage 225. Also, the NRT service manager 229 controls extraction of the NRT content from the file storage 225 when the user selects the corresponding NRT service. The EPG manager 230 receives the service guide data from the SG handler 227, and controls construction and display of EPG data. The application manager 231 performs general management related to processing of application data transmitted in an object/file format, for example. The UI manager 232 transmits user input to the operation controller 233 through a UI, and begins a process for a user request service. The operation controller 233 processes a user command transmitted through the UI manager 232, and controls a manager of a required module to perform a corresponding action. The presentation manager 234 provides the user with at least one of audio and video data output from the A/V decoders 218, the file data output from the M/W engine 226, and the EPG data output from the EPG manager 230 through a speaker and/or a screen. The PVR controller 235 controls the PVR storage 207 in conjunction with the operation controller 233.

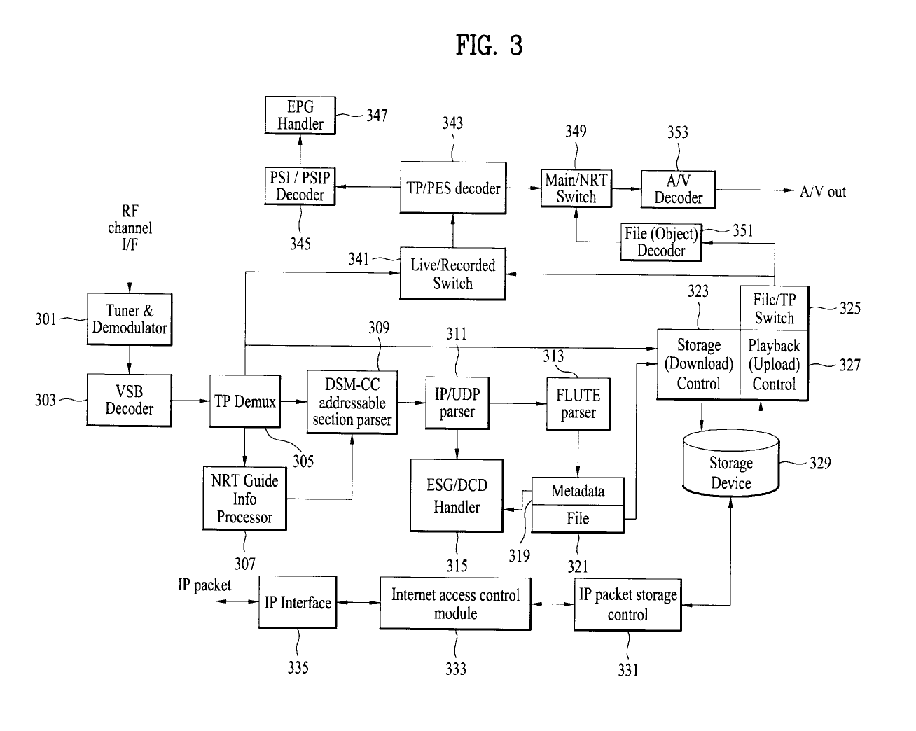

FIG. 3 is a functional block diagram showing an NRT broadcast receiver according to another embodiment of the present invention.

The NRT broadcast receiver according to another embodiment of the present invention may include a tuner & demodulator 301, a Vestigial Side Band (VSB) decoder 303, a TP Demux 305, an NRT guide information processor 307, a DSM-CC addressable section parser 309, an IP/UDP parser 311, a FLUTE parser 313, an Electronic Service Guide/Direct Stream Digital (ESG/DCD) handler 315, a metadata processor 319, a file processor 321, a storage (download) controller 323, a file/TP switch 325, a playback (upload) controller 327, a storage 329, an IP packet storage controller 331, an Internet access control module 333, an IP interface 335, a live/recorded switch 341, a TP/PES decoder 343, a PSI/PSIP decoder 345, an EPG handler 347, a main/NRT switch 349, a file (object) decoder 351, and an AV decoder 353.

Here, similar to the above-described broadcast receiver of FIG. 2, the broadcast receiver of FIG. 3 may perform a function of the PVR, and thus may perform recording, schedule recording, and time-machine functions in association with the NRT service or content according to the present invention.

Hereinafter, the respective constituent elements of the broadcast receiver shown in FIG. 3 will be described. A description of the same or similar constituent elements to the above-described constituent elements shown in FIG. 2 will be replaced with the above description and will not be descried in detail.

The tuner & demodulator 301 and the VSB decoder 303 have the same function as the baseband processor. That is, the tuner & demodulator and the VSB decoder tune to a particular channel, and demodulate a received broadcast signal. Here, the received broadcast signal may include the NRT service, and in turn the NRT service may include a 3D service or content.

The TP Demux 305 serves to demultiplex various information included in the TP from the broadcast signal, thereby allowing each element of the broadcast signal to be processed in each part of the NRT broadcast receiver.

The NRT guide information processor 307 processes NRT guide information included in the broadcast signal.

The DSM-CC addressable section parser 309 parses the DSM-CC addressable section from the NRT guide information. In this course, a source for transmitting data required for the NRT service may be acquired through the NRT guide information. For example, the DSM-CC addressable section parser 309 may acquire an IP address for transmission of the IP packet used in the NRT broadcast from the NRT guide information.

The IP/UDP parser 311 parses the packet used in the NRT service that is transmitted in the IP/UD.

The FLUTE parser 313 processes FLUTE data from the parsed packet.

The ESG/DCD handler 315 processes an EPG associated with a broadcast program and/or a downlink channel descriptor.

The metadata processor 319 and the file processor 321 serve to process the FLUTE data processed in the FLUTE parser 313 into metadata/files.

The storage (download) controller 323 receives an output of the TP Demux and an output of the file processor 321, and controls storage or download to the file or TP storage 329 under control of the file/TP switch 325.

On the contrary, the playback (upload) controller 327 controls upload of the file and/or the TP stored in the storage 329 under control of the file/TP switch 325. In this case, among outputs of the playback (upload) controller 327, the TP is decoded in the TP/PES decoder 343 by way of the live/recorded switch 341. On the contrary, among outputs of the playback (upload) controller 327, the file is decoded in the file (object) decoder 351. The decoded output of the TP/PES decoder 343 and the output of the file (object) decoder 351 are appropriately selected by the main/NRT switch 349, and are decoded in the A/V decoder 353.

The metadata handler 315 may process information input from the IP/UDP parser 311 as well as the metadata processor 319, and transmit the processed information to the 3D formatter 357.

If the demultiplexed TP from the TP demultiplxer 305 is input through the TP/PES decoder 343, the PSI/PSIP decoder 345 reads the PSI/PSIP information from the TP/PES decoder, and decodes the read PSI/PSIP information. The decoded PSI/PSIP information is used to configure the EPG in the EPG handler 347.

The IP package storage controller 331 controls an IP package storage operation in the storage 329.

The Internet access control module 333 serves to control connection to an Internet source that provides data required for the NRT service.

The IP interface 335 serves to transmit or receive an IP packet required for the NRT service.

The above-described NRT broadcast receiver shown in FIG. 2 or FIG. 3 is given by way of example, and it will be appreciated that connection relationships between the respective functional elements may be changed via addition/omission of particular functional parts.

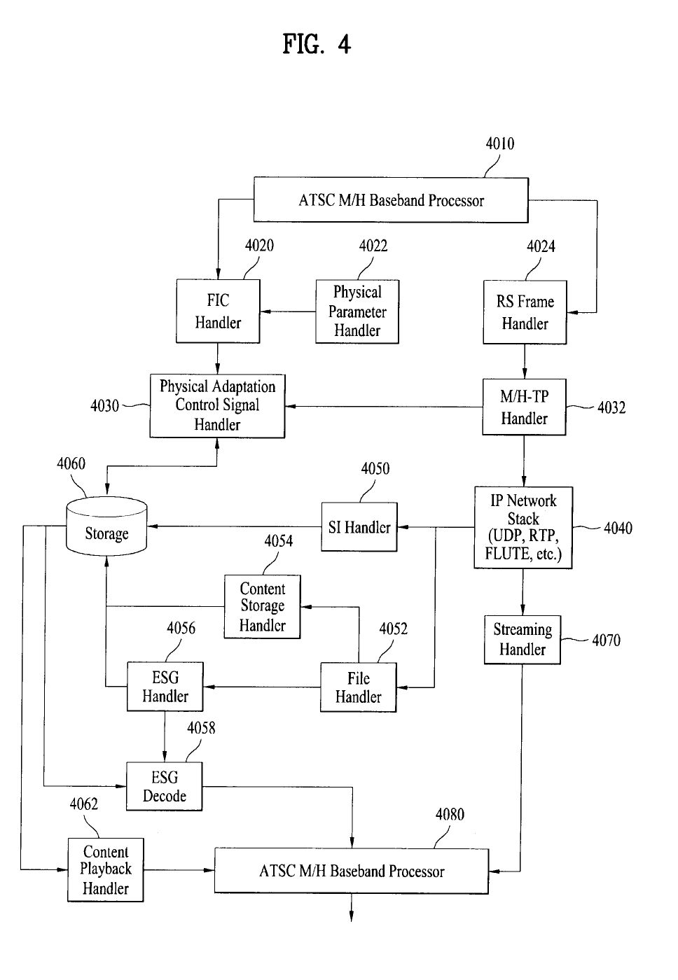

FIG. 4 is a functional block diagram showing a mobile NRT broadcast receiver that processes an NRT broadcast service according to an embodiment of the present invention.

The mobile NRT broadcast receiver according to the embodiment of the present invention may include a mobile baseband processor 4010, an FIC handler 4020, a physical parameter handler 4022, an RS frame handler 4024, a physical adaptation control signal handler 4030, a mobile transport stream (TP) handler 4032, an IP network processor 4040, a Service Information (SI) handler 4050, a file handler 4052, a content storage handler 4054, an ESG handler 4056, an ESG decoder 4058, a storage 4060, a content playback handler 4062, a streaming handler 4070, and a mobile presentation processor 4080.

The mobile baseband processor 4010 serves to receive and demodulate a broadcast signal for a mobile NRT service and convert the demodulated broadcast signal into a baseband signal. Also, the mobile baseband processor serves to transmit each element included in the broadcast signal to each block of the mobile NRT broadcast receiver.

The FIC handler 4020 serves to process Fast Information Channel (FIC) data that defines a connection between a physical layer included in the broadcast signal and an upper layer thereof. The FIC includes information to enable rapid acquisition of an NRT broadcast service from the broadcast signal.

The physical parameter handler 4022 processes transmission parameters associated with NRT broadcast service transmission/signaling. In an embodiment, the transmission parameters may be transmitted in a Transmission Parameter Channel (TPC) data format.

The RS frame handler 4024 serves to form an RS frame including NRT service data included in the broadcast signal and to process the NRT service data on a per RS frame basis. In an embodiment, the NRT service data may be included in a Reed Solomon (RS) frame as a 2D data frame and be and processed at a transmission terminal. More particularly, the RS frame handler forms an RS frame payload including the NRT service data, performs RS coding in a vertical row direction of the formed RS frame payload, inserts RS parity for correction of a forward error, performs Cyclic Redundancy Check (CRC) coding in a horizontal row direction of the RS payload, and inserts CRC checksum data for checking an error generated in the NRT service data corresponding to a horizontal row of the RS payload. If the RS frame including the RS parity and the CRC checksum is formed, the RS frame is divided into RS frame portions, and data in each RS frame portion is subjected to additional processing in a data group format and is transmitted in a Transport Stream (TS) format. As such, the RS frame handler 4024 provided at a receiving terminal may collect the NRT service data included in the NRT broadcast signal, form the RS data frame, and perform RS-CRC decoding on a per RS frame basis.

The physical adaptation control signal handler 4030 processes control associated with processing in a physical layer based on information of the FIC data and the TPC data.

The mobile transport stream (TP) handler 4032 processes a mobile transport stream included in the broadcast signal. In an embodiment, the mobile TP handler may process the NRT service data included in the RS frame processed in the RS frame handler 4024 on a per transport stream basis.

The IP network processor 4040 processes IP, UDP, and FLUTE data packets transmitted in the mobile transport stream.

The SI handler 4050 serves to process service information that provides information associated with the NRT service. In an embodiment, the service information associated with the NRT service may be transmitted through a particular IP address. A channel for transmitting the service information associated with the NRT service may be referred to as a Service Signaling Channel (SSC). In an embodiment of the present invention, a Service Map Table (SMT) including signaling information on the NRT service is transmitted through an SSC.

The file handler 4052 processes data associated with the NRT service in a file format. In an embodiment, the file handler 4052 may process, for example, announcement data, in addition to the data associated with the NRT service in the file format. The announcement data provides information on the NRT service. The announcement data may be transmitted in an OMA BCAST data format. Although the announcement data has been described as being processed in the file handler 4052, the announcement data may be processed in the above-described service information handler 4050 according to a designer.

The content storage handler 4054 serves to control storage of the NRT service/content.

The ESG handler 4056 processes data associated with the NRT service guide. An electronic program guide may serve as an NRT service guide.

The ESG decoder 4058 serves to decode the NRT service guide data.

The storage 4060 stores data associated with the NRT service. The storage may store data to directly configure the NRT service, data to configure the NRT service guide, and data associated with the NRT service information.

The content playback handler 4062 performs processing associated with playback of the NRT content stored in the storage.

The streaming handler 4070 processes received streaming service data included in the broadcast signal.

The mobile presentation processor 4080 serves to process display of a mobile service and/or a mobile NRT service.

The respective functional blocks of the mobile NRT broadcast receiver shown in FIG. 4 may be added or omitted, and therefore it is noted that connection relationships between the respective functional blocks are not limited to the above description.

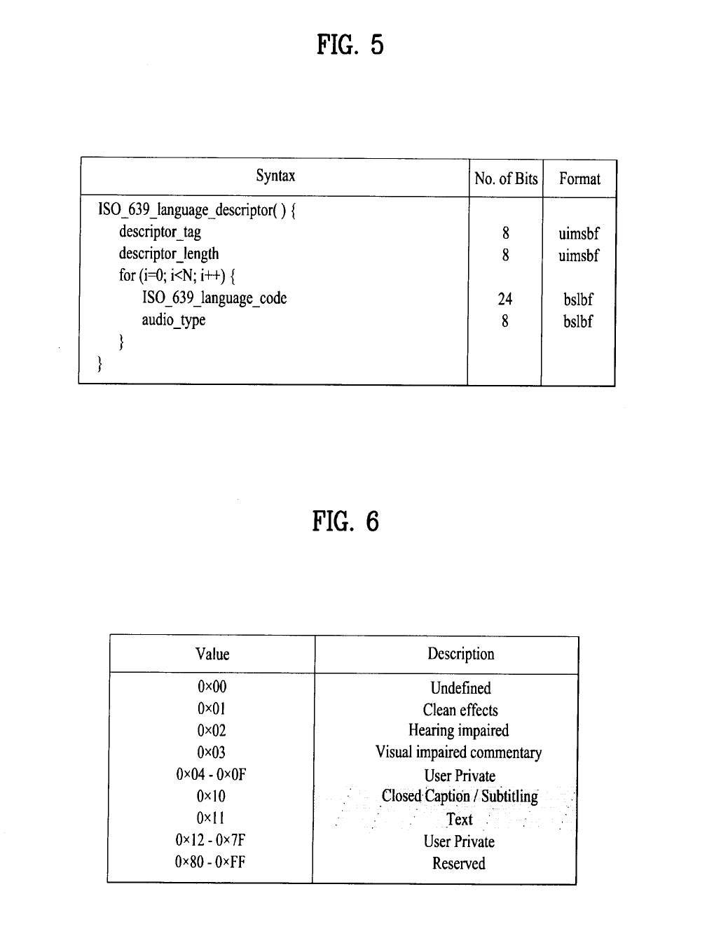

FIG. 5 is a diagram showing an ISO_{—}639_language_descriptor according to an embodiment of the present invention.

According to an embodiment of the present invention, the ISO_{—}639_language_descriptor may be included and transmitted in the SMT and/or the NRT-IT.

The SMT and/or the NRT-IT may be transmitted through the SSC. The SSC is a channel for transmitting signaling information associated with the NRT service. In an embodiment of the present invention, the SMT and/or the NRT-IT are transmitted through a particular IP address and a particular port number.

The SMT may include property information on a service level for the NRT service. In an embodiment, the property information on the service level refers to property information on all particular broadcast channels.

Unlike the mobile NRT broadcast, stationary NRT broadcast may include data for transmission of only service information, such as PSIP and PSI data, among broadcast signals transmitted through a digital broadcast network. The PSIP/PSI data includes a Virtual Channel Table (VCT) including property information on a virtual channel transmitted through a transport stream. The VCT includes information to identify whether a service transmitted through the corresponding virtual channel is the NRT service or not. If the broadcast receiver identifies, based on the aforementioned identification information, that the service transmitted through the corresponding virtual channel is the NRT service, the broadcast receiver acquires program number information to identify a program of the virtual channel included in the VCT, and parses a Program Association Table (PAT) including program number information matched to the program number information of the VCT. In another embodiment, the broadcast receiver may parse a PAT including the same identification value as information to identify the transport stream of the channel included in the VCT. The PAT is a service information table including property information associated with programs.

The broadcast receiver parses a Program Map Table (PMT) that is identified by a program map packet identifier included in the PAT. Here, the program map packet identifier serves to identify the PMT including property information on a program which is associated with program number information and is identified by the corresponding program number information.

The parsed PMT includes an elementary packet identifier. The elementary packet identifier serves to identify a transport stream packet that transmits NRT data associated with a corresponding program. The transport stream packet for transmission of the associated NRT data may be included and transmitted in an IP multicast stream.

Among the data transmitted in the IP multicast stream, the SSC may be transmitted through a particular IP address and a particular port number. The SMT and/or the NRT-IT are transmitted through the SSC. If the ISO_{—}639_language_descriptor is included in the SMT, the ISO_{—}639_language_descriptor provides language information on a per NRT service basis. If the ISO_{—}639_language_descriptor is included in the NRT-IT, the ISO_{—}639_language_descriptor provides language information on a per NRT content basis.

The ISO_{—}639_language_descriptor may include a descriptor_tag field, a descriptor_length field, an ISO_{—}639_language_code field, and an audio_type field.

The descriptor_tag field serves to identify the type of a descriptor, and the descriptor_length field serves to identify the magnitude (length) of a descriptor.

The ISO_{—}639_language_code field identifies the language associated with a program element. For example, the ISO_{—}639_language_code field may allow the broadcast receiver to recognize a language among various languages, such as Korean, English, French, and so on, used in a corresponding program. The broadcast receiver identifies that the language identified by the ISO_{—}639_language_code field is a language used in the program element identified by the audio_type field that will be described below.

The audio_type field includes information to identify the type of an NRT broadcast stream.

FIG. 6 is a diagram showing the type of an element of an NRT service that is identified by the audio_type field according to an embodiment of the present invention.

If the audio_type field has a value of 0x00, this indicates that the type of a program element is undefined.

If the audio_type field has a value of 0x01, this indicates that a program element does not include language.

If the audio_type field has a value of 0x02, this indicates that a program element for a hearing impaired viewer is present.

If the audio_type field has a value of 0x03, this indicates that a program element for a visually impaired viewer is present.

If the audio_type field has a value of 0x10, it will be appreciated that a language indicated by the ISO_{—}639_language_code field is a language of captions/subtitles.

Also, if the audio_type field has a value of 0x11, it will be appreciated that a language indicated by the ISO_{—}639_language_code field is associated with text data. In this case, text may be language information on a web portal/webpage, or data configured of only text (e.g., e-book). As such, for example, if web pages having the same content are present in various language versions, the user can select a webpage in a desired language.

If the audio_type field has a value in a range from 0x12 to 0x7F, the NRT broadcast stream is defined as a code that can be used by a broadcast business operator or private user.

The audio_type field having a value in a range from 0x80 to 0xFF is reserved for future use.

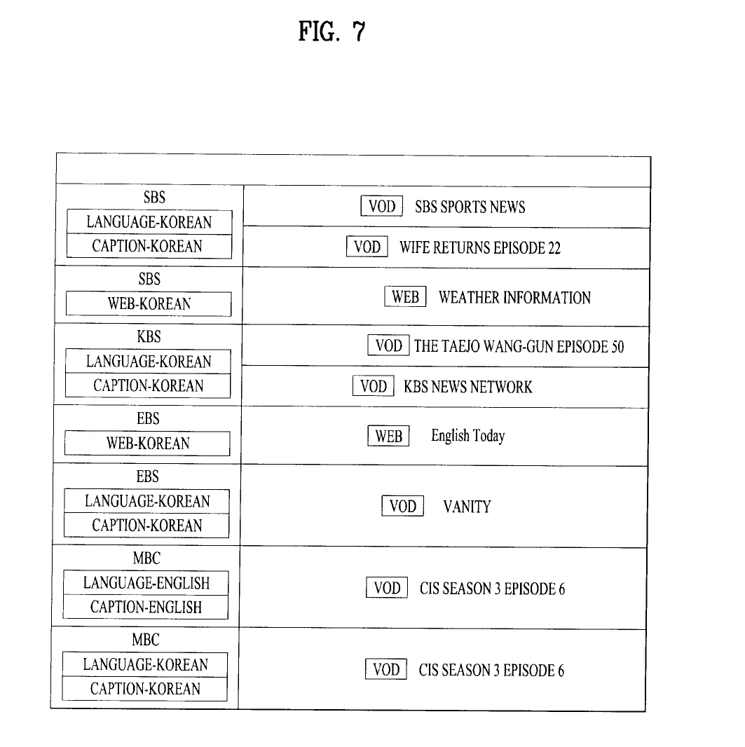

FIG. 7 is a diagram showing language information regarding captions or text displayed on a per service basis by an electronic program guide according to an embodiment of the present invention.

If the ISO_{—}639_language_descriptor is included in the SMT, language information on text and/or captions (subtitles) of an NRT service level may be signaled through the ISO_{—}639_language_descriptor.

As described above, the broadcast receiver accesses an IP level through the VCT, and parses the NRT SMT. The broadcast receiver parses the ISO_{—}639_language_descriptor with respect to each NRT service included in the SMT. The broadcast receiver identifies language indicated by the value of the ISO_{—}639_language_code field of the ISO_{—}639_language_descriptor. In an embodiment, if the value of the ISO_{—}639_language_code field is “kor”, a corresponding language is identified as Korean.

The broadcast receiver identifies the value of the audio_type field included in the ISO_{—}639_language_descriptor. If the audio_type field has a value of 0x10, the broadcast receiver recognizes that a corresponding service provides captions. That is, Korean identified by the value of the ISO_{—}639_language_code field is a language of the captions of the corresponding service.

In an embodiment of the present invention, if a broadcast service list is provided via, for example, an electronic program guide, language information on captions with respect to each service may be provided. For example, the type of a service provided by each broadcast station and language information may be displayed along with identifiers for the corresponding service.

As shown in FIG. 7, a viewer can select and watch each service after confirming a language provided by each service and a program element to which the corresponding language is applied.

Also, as shown in FIG. 7, assuming that the same broadcast station (for example, “MBC”) provides the same content, for example, “CSI Season 3, Episode 6”) through two channels, one of which provides Korean captions and the other of which provides English captions, the viewer can previously confirm language information on captions of the corresponding content, and select a service channel that provides desired language captions.

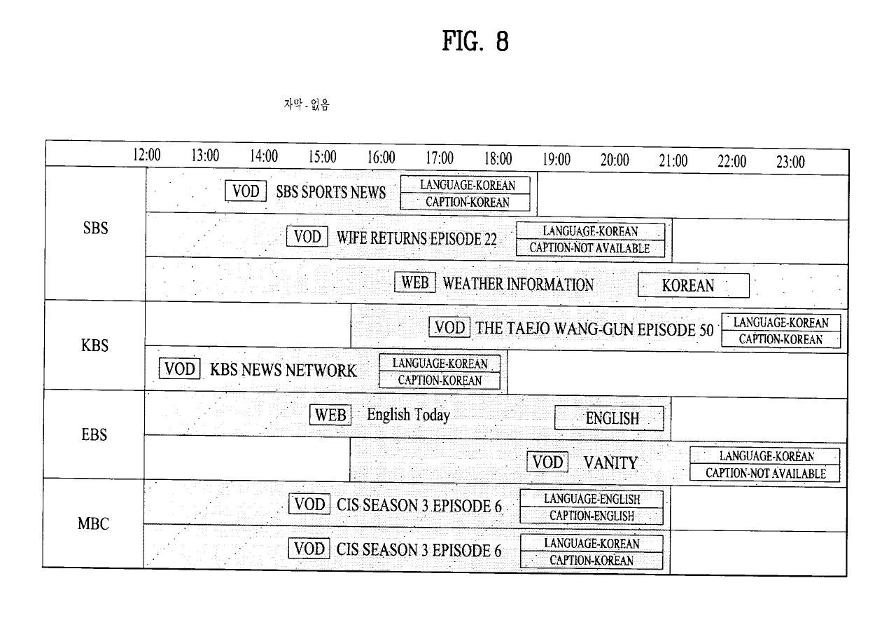

FIG. 8 is a diagram showing language information regarding captions or text displayed on a per content basis by the electronic program guide according to an embodiment of the present invention.

The NRT-IT is a service information table including information on downloadable content items that may be stored in the storage of the broadcast receiver.

In an embodiment of the present invention, the NTR-IT is present on a per NRT service basis, and consists of a plurality of instances, thereby being capable of providing information on each content.

If the ISO_{—}639_language_descriptor is included in the NRT-IT, captions (subtitles) of an NRT content level and/or language information on text may be signaled through the ISO_{—}639_language_descriptor.

As described above, the broadcast receiver accesses the IP level through the VCT, and parses the NRT SMT. The broadcast receiver identifies and parses the NRT-IT associated with a corresponding service via service identifiers included in the SMT.

The broadcast receiver parses the ISO_{—}639_language_descriptor included in the NRT-IT.

The broadcast receiver recognizes language information on corresponding content using the ISO_{—}639_language_code field and the audio_type field included in the ISO_{—}639_language_descriptor with respect to each content.

The broadcast receiver may reserve download of all NRT content having program elements provided by corresponding languages by a user selection or using set information on preferable language input by the user. Of course, all NRT content may be recorded regardless of languages.

The broadcast receiver may receive and store all service identifiers of services providing respective recorded content during broadcast of NRT content. In this case, values of the service identifiers included in the NRT-IT of services providing the respective content may be used.

In the case in which all NRT content is recorded regardless of languages, if the user pushes a language switch button when playing back stored content, the content may be switched to content including a corresponding language and the switched content may be played back. For example, if the same broadcast station (for example, “MBC”), to which a particular channel is allotted, provides any content (for example, “CSI Season 3, Episode 6”) in a particular time slot, the viewer who is watching content including English captions may switch a screen to display content including Korean captions using the language switch button.

An NRT_service_descriptor may be present in the SMT or in the NRT-IT. The NRT_service_descriptor announces the presence of an NRT element in a service and also announces a use/consumption model for the NRT service. For example, the NRT_service_descriptor may include an NRT service category field (or an NRT_consumption_model field) for signaling an intended service model of the NRT service. If the NRT service category field has a value of 0x01, this indicates that browsing and/or selective download of content of the NRT service are possible. If the NRT_service_category field has a value of 0x02, this indicates that the NRT service provides similar service/content to that provided by a web browser. If the NRT service category field has a value of 0x03, this indicates that the NRT service provides content based on a user request.

According to an embodiment of the present invention, if the NRT_service_category field has a value of 0x01 or 0x03, for example, the electronic program guide may display that a particular NRT service or content is VoD. If the NRT_service_category field has a value of 0x02, for example, the electronic program guide may display that a particular NRT service or content is a web page service.

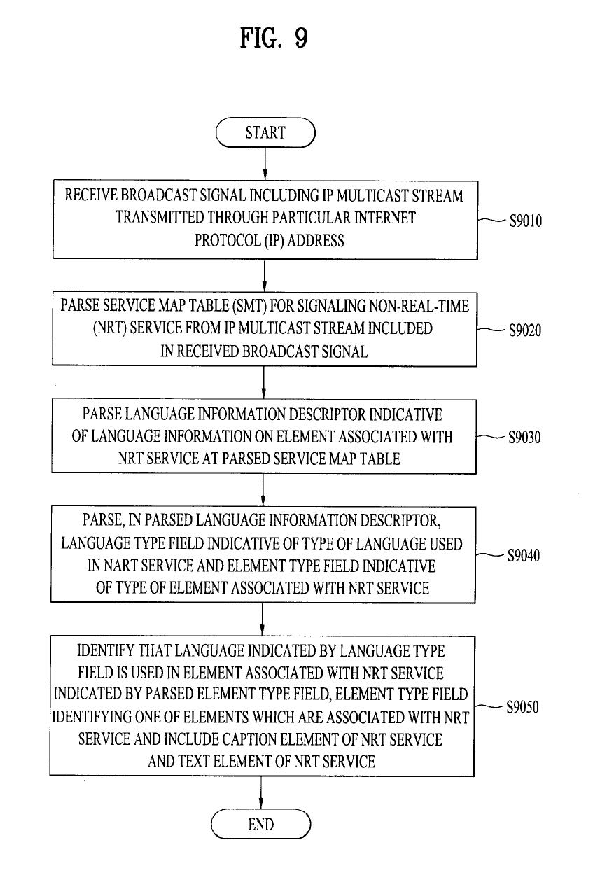

FIG. 9 is a flowchart showing a method for processing an NRT service transmitted via a broadcast signal according to an embodiment of the present invention.

The broadcast receiver receives a broadcast signal including an IP multicast stream transmitted through a particular IP address (S9010). In an embodiment, SSC data may be transmitted through the particular IP address.

The broadcast receiver parses SMT data for signaling an NRT service from the IP multicast stream included in the received broadcast signal (S9020).

The broadcast receiver parses a language information descriptor indicative of language information of an element associated with the NRT service at the parsed SMT (S9030). As described above, in the case of signaling the language information on a per NRT content basis, an operation of parsing an NRT-IT having the same service identifier as a service identifier included in the SMT may be further performed. The parsed NRT-IT may include a plurality of instances, and each instance provides property information on the NRT content. As the language information descriptor is included in the NRT-IT, language information of program elements provided by each NRT content may be provided.

The broadcast receiver parses, in the language information descriptor, a language type field indicative of the type of language used in the NRT service or content and an element type field indicative of the type of an element associated with the NRT service or content (S9040).

The broadcast receiver identifies that the language indicated by the language type field is used in the element associated with the NRT service or content indicated by the parsed element type field (S9050).

Here, the element type field may identify one of elements which are associated with the NRT service and include a caption element of the NRT service and a text element of the NRT service.

According to another embodiment of the present invention, the broadcast receiver may receive the language information descriptor through announcement data (for example, OMA BCAST service guide data). In this case, the broadcast receiver may parse the language information descriptor at the announcement data, and identify language information on a per NRT service or content basis.

According to some embodiments of the present invention, it is possible to provide the NRT service using a conventional broadcast system. Moreover, in relation to provision of the NRT service, it is possible to provide the user with language information on captions and text elements included in the NRT service or content, resulting in a user centered broadcast service.

Although the present invention has been described with reference to the embodiments and the drawings, the present invention is not limited to the above embodiments, and those skilled in the art will appreciate that various modifications and variations can be made from the above description. Accordingly, the invention should not be limited to the specific embodiments described herein, but should be determined by the following claims and equivalents thereof.

### MODE FOR INTENTION

As described above, related items have been discussed in the above “Best Mode”.

### INDUSTRIAL APPLICABILITY

As described above, the present invention may be used to provide an NRT service using a conventional broadcast system.

1. A method for processing a Non Real Time (NRT) service transmitted in a broadcast signal, the method comprising:
receiving the broadcast signal including an Internet Protocol (IP) multicast stream transmitted through a particular IP address;
parsing a Service Map Table (SMT) for signaling the NRT service from the IP multicast stream included in the received broadcast signal;
parsing a language information descriptor indicative of language information on an element associated with the NRT service at the parsed service map table;
parsing, in the parsed language information descriptor, a language type field indicative of the type of language used in the NRT service and an element type field indicative of the type of an element associated with the NRT service; and
identifying that the language indicated by the language type field is used in the element associated with the NRT service indicated by the parsed element type field,
wherein the element type field identifies one of elements which includes a caption element of the NRT service, and an element associated with the NRT service including a text element of the NRT service.

2. The method according to claim 1, further comprising:
receiving the broadcast signal through a digital broadcast network;
parsing a Virtual Channel Table (VCT) including property information on a virtual channel transmitted by a transport stream, included in the received broadcast signal;
if the type of a service indicated by service type information that is included in the parsed VCT is a particular NRT service, parsing a Program Association Table (PAT) including second program number information matched to first program number information that is included in the VCT to identify a program of the virtual channel;
parsing a Program Map Table (PMT) identified by a program map packet identifier that is included in the parsed PAT; and
identifying the IP multicast stream from transport stream packets indicated by an elementary packet identifier that is included in the parsed PMT.

3. The method according to claim 1, wherein the text element of the NRT service is a text element of a web portal service or an electronic book (e-book) service that is provided as the NRT service.

4. The method according to claim 1, further comprising displaying a guide list with respect to NRT services by mapping the type of language indicated by the language type field to the NRT service.

5. A method for processing NRT content transmitted in a broadcast signal, the method comprising:
receiving the broadcast signal including an IP multicast stream transmitted through a particular IP address;
parsing an SMT for signaling the NRT service from the IP multicast stream included in the received broadcast signal;
parsing an NRT information table including information on the NRT content provided by an NRT service, wherein the NRT information table includes a second service identifier having the same value as a value of a first service identifier that is included in the parsed service map table to identify the NRT service;
parsing a language information descriptor indicative of language information on an element associated with the NRT content at the parsed NRT information table;
parsing, in the parsed language information descriptor, a language type field indicative of the type of language used in the NRT content and an element type field indicative of the type of an element associated with the NRT content; and
identifying that the language indicated by the language type field is used in the element associated with the NRT content indicated by the parsed element type field,
wherein the element type field identifies one of elements which includes a caption element of the NRT service, and an element associated with the NRT service including a text element of the NRT service.

6. The method according to claim 5, further comprising:
receiving the broadcast signal through a digital broadcast network;
parsing a VCT including property information on a virtual channel transmitted by a transport stream, included in the received broadcast signal;
if the type of a service indicated by service type information that is included in the parsed VCT is a particular NRT service, parsing a PAT including second program number information matched to first program number information that is included in the VCT to identify a program of the virtual channel;
parsing a PMT identified by a program map packet identifier that is included in the parsed PAT; and
identifying the IP multicast stream from transport stream packets indicated by an elementary packet identifier that is included in the parsed PMT.

7. The method according to claim 5, wherein the text element of the NRT content is a text element of web portal content or electronic book (e-book) content that is provided as the NRT content.

8. The method according to claim 5, further comprising displaying a guide list with respect to NRT content by mapping the type of language indicated by the language type field to the NRT content.

9. The method according to claim 8,
wherein the SMT includes an NRT service descriptor that includes information on NRT service use or consumption models, and
wherein the NRT service descriptor includes an NRT service category field indicative of at least one of the NRT service consumption models including NRT content that can be selected for later downward, web portal content, and NRT content based on a user request.

10. The method according to claim 9, wherein the displaying includes:
displaying that the corresponding NRT content is Video on Demand (VoD) content if the NRT service category field indicates that the NRT service consumption model is the NRT content that can be selected for later downloaded, or the NRT content based on the user request; and
displaying that the corresponding NRT content is web content if the NRT service category field indicates that the NRT service consumption model is the web portal content.
